(19) United States
(12) Patent Application Publication
(10) Pub. No.: US 2016/0089689 A1
(43) Pub. Date: Mar. 31, 2016

(54) Dispensing Package Comprising Internal Package Fitment

(71) Applicant: Cryovac, Inc., Duncan, SC (US)

(72) Inventor: Hubert J. Cook, Simpsonville, SC (US)

(21) Appl. No.: 14/499,561

(22) Filed: Sep. 29, 2014

(51) Int. Cl. B05C 17/005; B65D 65/38; B65D 43/02; A47J 47/02; B65D 25/16

(52) U.S. Cl. CPC B05C 17/00596; A47J 47/02; B65D 25/16; B65D 43/02; B65D 65/38; B65D 2565/388

(57) ABSTRACT

The presently disclosed subject matter provides a system and method for dispensing a product onto one or more areas simultaneously. Particularly, the disclosed system cooperates with a dispensing device (such as a dispensing gun) to dispense a metered dose of product. The disclosed system comprises an outer container and a pouch positioned within the container interior. The pouch comprises a rigid or semi-rigid film fitment that enables dispensing of the packaged product.

### FIELD OF THE INVENTION

The presently disclosed subject matter relates generally to a system for dispensing a packaged product. More particularly, the presently disclosed system can be used in conjunction with a dispensing device (such as a dispensing gun) to facilitate controlled release of a packaged product (such as a condiment) onto one or more areas simultaneously.

### BACKGROUND

In the field of high volume fast food service, it is frequently desired that food be supplemented by condiments such as ketchup, mustard, mayonnaise, and the like. It has recently become customary in retail fast food service outlets to use a wide variety of devices to dispense a measured quantity of flowable product. For example, trigger-activated dispensing guns have commonly been used in “back of the restaurant” operations for discharging one or more condiments or sauces. The gun dispenses an accurately measured quantity of a condiment with each pull of the gun trigger. The gun includes a container that houses the condiment and uses a trigger to dispense the condiment from nozzle. However, the gun, condiment container, and nozzle must be disassembled and cleaned each time the container is emptied and/or refilled. In addition, the gun assembly typically can be messy, as condiment can drip from the nozzle between uses. Further, conventional dispensing guns are limited to providing a single spot of dispensed product, rather than 2 or more spots of product simultaneously. Thus, prior devices have numerous shortcomings, including complexity, expense, imprecise measuring, cleanliness, and the like.

The presently disclosed subject matter is directed to a system and method that addresses one or more of the cited shortcomings.

### SUMMARY

In some embodiments, the presently disclosed subject matter is directed to a packaging system comprising a hollow outer container and a pouch positioned within the container interior. The container comprises (i) a first end comprising a container opening; (ii) an open second end; and (iii) an interior. The pouch comprises (i) a first end comprising a pouch opening positioned to align with the container opening; (ii) a second end; (iii) an interior; and (iv) a fitment comprising at least one aperture, wherein the fitment is positioned within the pouch interior to overlie the pouch opening.

In some embodiments, the presently disclosed subject matter is directed to a method of dispensing a product. The method comprises providing the disclosed system, at least partially filling the pouch with a product to be dispensed, providing a dispensing gun configured to house the disclosed system, inserting the system into the dispensing gun, and initiating movement of the disc towards the first end of the container, wherein movement of the disc dispenses the product through the at least one fitment aperture.

### BRIEF DESCRIPTION OF THE DRAWINGS

FIG. 1a is a perspective view of one embodiment of the disclosed system.

FIG. 1b is a sectional view of the system of FIG. 1.

FIG. 2 is a perspective view of one embodiment of the disclosed container.

FIG. 3a is a lay flat view of one embodiment of a pouch in accordance with some embodiments of the presently disclosed subject matter.

FIG. 3b is a fragmentary sectional view of one embodiment of a fitment in accordance with the presently disclosed subject matter.

FIGS. 3c and 3d are top plan views of one embodiment of the disclosed fitment.

FIGS. 3e and 3f are fragmentary sectional views of two embodiments of the disclosed fitment.

FIGS. 4a and 4b are perspective views illustrating one embodiment of assembling the disclosed package.

FIGS. 5a and 5b are side plan views illustrating one embodiment of loading the system into a dispensing device.

### DETAILED DESCRIPTION

### I. General Considerations

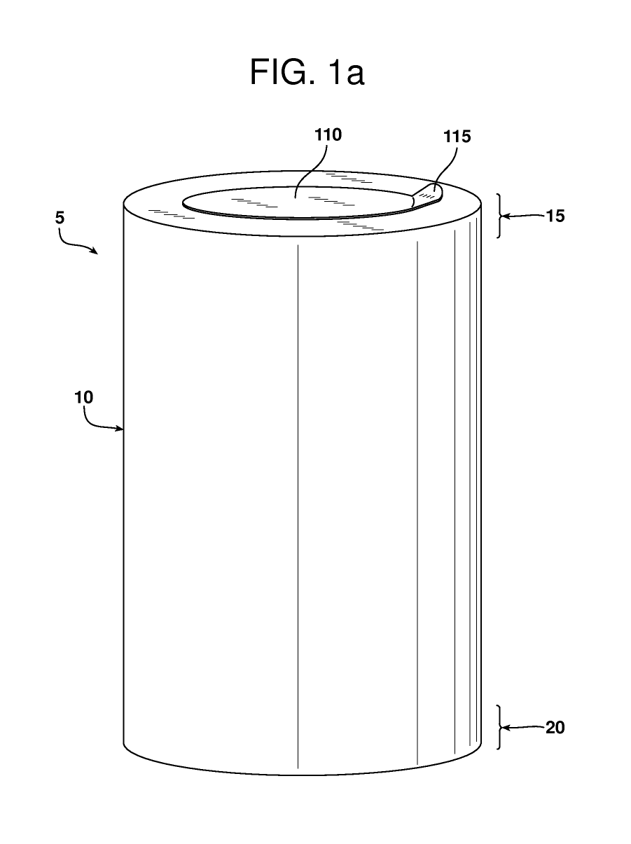

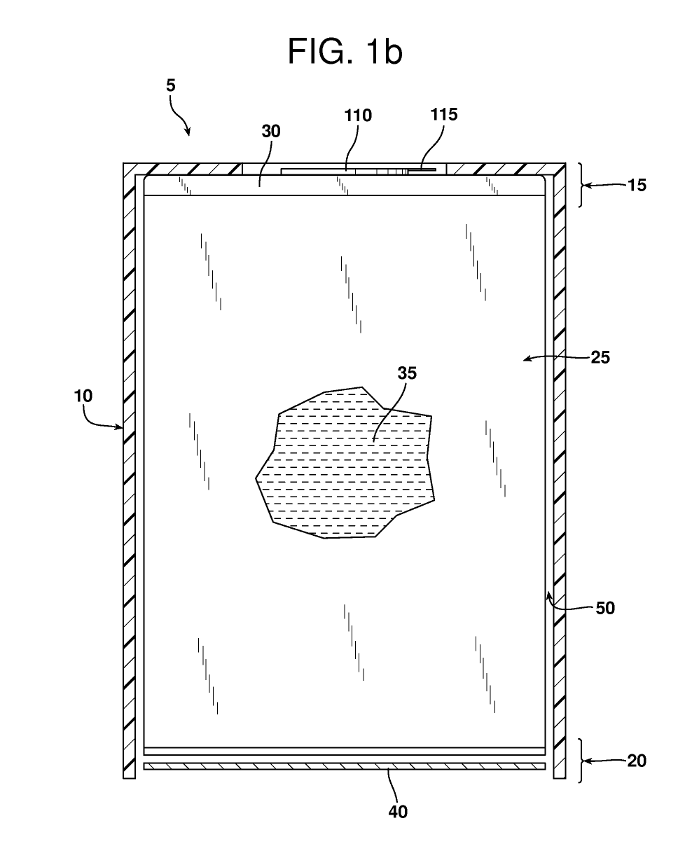

The presently disclosed subject matter provides a system and method for dispensing a product onto one or more areas simultaneously (one or more spots of mustard dispensed on a hamburger bun, for example). Particularly, the disclosed system cooperates with a dispensing device (such as a dispensing gun) to dispense a metered dose of product. As illustrated in FIGS. 1a and 1b, system 5 comprises outer container 10 with first and second ends 15, 20 and pouch 25 positioned within the container interior. Pouch 25 comprises rigid or semi-rigid film fitment 30 that enables packaged product 35 to exit the system, as set forth in more detail herein below. Disc 40 is configured on the interior of container second end 20 and cooperates with a dispensing gun to dispense product 35.

### II. Definitions

Following long-standing patent law convention, the terms “a”, “an”, and “the” do not limit to the singular unless expressly so stated. Thus, for example, reference to “a package” can include a plurality of such packages, and so forth.

As used herein, the term “abuse layer” can refer to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, the abuse layer can comprise polyamide, ethylene/propylene copolymer, and/or combinations thereof.

As used herein, the terms “barrier” and/or “barrier layer” can refer to the ability of a film or film layer to serve as a barrier to one or more gases. For example, oxygen barrier layers can comprise, but are not limited to, ethylene/vinyl alcohol copolymer, polyvinyl chloride, polyvinylidene chloride, polyamide, polyester, polyacrylonitrile, and the like, as known to those of ordinary skill in the art. In some embodiments, the barrier film or layer has an oxygen transmission rate of no more than 100 cc O₂/m²·day·atm; in some embodiments, less than 50 cc O₂/m²·day·atm; in some embodiments, less than 25 cc O₂/m²·day·atm; in some embodiments, less than 10 cc O₂/m²·day·atm; in some embodiments, less than 5 cc O₂/m²·day·atm; and in some embodiments, less than 1 cc O₂/m²·day·atm (tested at 1 mil thick and at 25° C. in accordance with ASTM D3985, herein incorporated by reference in its entirety).

As used herein, the term “bulk layer” can refer to any layer of a film that is present for the purpose of increasing the abuse-resistance, toughness, and/or modulus of a film. In some embodiments, bulk layers can comprise polyolefin, ethylene/alpha-olefin copolymer, ethylene/alpha-olefin copolymer plastomer, low density polyethylene, linear low density polyethylene, and combinations thereof.

The term “condiment” as used herein refers to (but is not limited to) ketchup, mustard, guacamole, sour cream, salsa, nacho cheese, taco sauce, barbecue sauce, tartar sauce, mayonnaise, jams, jellies, spices, and the like. In some embodiments, the term “condiment” can include any and all additives that a user can add to any food item for any purpose.

The term “container” is intended to include tubes, bottles, jars, tubs, cylinders, vessels, flasks, chambers, and the like, whether pliable or rigid.

The term “dispensing gun” refers to any apparatus that cooperates with the disclosed system to dispense a product. See, for example, U.S. Pat. Nos. 4,681,524; 5,211,311; 5,242,115; 5,462,204; 5,589,226; 5,812,355; and 5,875,922, the entire contents of which are hereby incorporated by reference herein.

As used herein, the term “film” can include, but is not limited to, a laminate, sheet, web, coating, and/or the like, that can be used to package a product. The film can be a rigid, semi-rigid, or flexible product. In some embodiments, the disclosed film is produced as a fully coextruded film, i.e., all layers of the film emerging from a single die at the same time. In some embodiments, the film is made using a flat cast film production process or a round cast film production process. Alternatively, the film can be made using a blown film process, double bubble process, triple bubble process, and/or adhesive or extrusion coating lamination in some embodiments. Such methods are well known to those of ordinary skill in the art.

The term “fitment” as used herein refers to a unit for accessing a vessel (such as a pouch) and can include, without limitation, valves, ports, port enclosure assemblies, and other units for accessing a vessel. Fitments provide fluid communication between the contents of a vessel and the outside environment.

The term “flexible” as used herein refers to materials that are compliant and easily deform in the presence of external forces.

As used herein, the term “heat seal” refers to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. In some embodiments, heat-sealing can be inclusive of thermal sealing, melt-bead sealing, impulse sealing, dielectric sealing, and/or ultrasonic sealing. The heating can be performed by any one or more of a wide variety of means, such as (but not limited to) a heated bar, hot wire, hot air, infrared radiation, ultrasonic sealing, and the like.

The term “interior” as used herein with regard to an article refers to the actual inside portion of the article. Likewise, the term “exterior” refers to the actual outside portion of the article.

As used herein, the term “multilayer film” can refer to a thermoplastic film having one or more layers formed from polymeric or other materials that are bonded together by any conventional or suitable method, including one or more of the following methods: coextrusion, extrusion coating, lamination, vapor deposition coating, solvent coating, emulsion coating, or suspension coating.

The term “pouch” as used herein is not limiting and includes the wide variety of containers known in the art, including (but not limited to) bags, packets, packages, and the like. “Filled” with respect to a pouch herein can refer to a pouch that has been filled with a product in a manner consistent with a commercial filling operation. Thus, the pouch may or may not be 100% filled.

The term “product” as used herein refers to any of a wide variety of food or non-food items that can be packaged in the disclosed system. For example, in some embodiments, the product can be a condiment. In some embodiments, the product can be a flowable product.

The term “rigid” as used herein refers to a material that has a high stiffness or modulus of elasticity. In some embodiments, a rigid material in accordance with the presently disclosed subject matter has a modulus of elasticity of about 0.5×10⁶ psi or greater. Thus, a rigid material holds a shape without external support has a high resistance to deformation by external forces. The term “semi-rigid” refers to materials or articles that hold a shape without external support, but exhibit higher flexibility when external forces are exerted on the structure.

As used herein, the term “seal” can refer to any seal of a first region of a film surface to a second region of a film or substrate surface. In some embodiments, the seal can be formed by heating the regions to at least their respective seal initiation temperatures using a heated bar, hot air, infrared radiation, ultrasonic sealing, and the like. In some embodiments, the seal can be formed by an adhesive. Such adhesives are well known in the packaging art. Alternatively or in addition, in some embodiments, the seal can be formed using a UV or e-beam curable adhesive seal.

As used herein, the terms “seal layer”, “sealing layer”, “heat seal layer”, and/or “sealant layer” refer to an outer film layer or layers involved in heat sealing of the film to itself, another film layer of the same or another film, and/or another product that is not a film. Heat sealing can be performed by any one or more of a wide variety of manners known to those of ordinary skill in art, including using heat seal technique (e.g., melt-bead sealing, thermal sealing, impulse sealing, ultrasonic sealing, hot air, hot wire, infrared radiation, and the like), adhesive sealing, UV-curable adhesive sealing, and the like.

As used herein, the term “tie layer” can refer to any internal film layer having the primary purpose of adhering two layers to one another. In some embodiments, the tie layers can comprise any nonpolar polymer having a polar group grafted thereon, such that the polymer is capable of covalent bonding to polar polymers such as polyamide and ethylene/vinyl alcohol copolymer. In some embodiments, the tie layers can comprise, but are not limited to, modified polyolefin, modified ethylene/vinyl acetate copolymer, and/or homogeneous ethylene/alpha-olefin copolymer.

The definitions and disclosure of the present application control over any inconsistent definitions and disclosures that may exist in an incorporated reference.

### III. Package 5

II.A. Generally

As set forth herein above, the presently disclosed subject matter is directed generally to a dispensing system that can cooperate with a dispensing gun to deliver a metered dose of product. As shown in FIGS. 1a and 1b, system 5 can comprise outer container 10, pouch 25, and disc 40, each of which is individually discussed herein below. In some embodiments, the system further comprises a conventional dispensing gun.

III.B. Container 10

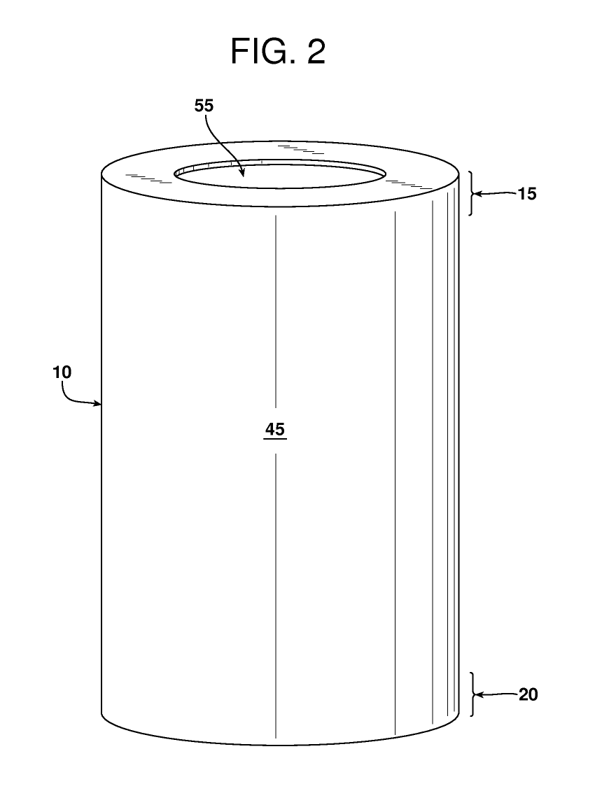

FIG. 2 illustrates hollow outer container 10 according to some embodiments of the presently disclosed subject matter. Particularly, container 10 includes tubular sidewall 45 with opening 55 positioned at first end 15, through which product can be dispensed (via film fitment 60). The container further includes open second end 20 sized to house pouch 25 and disc 40 within container interior 50.

Container 10 can be constructed from any of a wide variety of rigid or semi-rigid materials known in the art, including (but not limited to) plastic, metal, wood, cardboard, chipboard, stiff paper, foamed plastics, recycled materials, compostable materials, heavy foil, and/or combinations thereof. Thus, in some embodiments, container 10 can be constructed from any of a wide variety of polymeric materials known in the art, including (but not limited to) foamed or solid polystyrene, crystallized polystyrene (CPS), polyethylene terephthalate (PET), polypropylene, polyethylene, or combinations thereof. Such materials are typically suitable for forming, yet stiff or rigid enough to resist buckling, folding, crumbling or collapsing due to compression, handling, and shipping.

In some embodiments, container 10 can be constructed from a material that itself provides a barrier to the passage of oxygen, e.g., vinylidene chloride copolymer, nylon, polyethylene terephthalate, ethylene/vinyl alcohol copolymer, and the like. In some embodiments, the material(s) from which the container is constructed can comprise an oxygen scavenging material, such as (but not limited to) Amisorb®. Alternatively or in addition, container 10 can comprise a substantially gas-impermeable sealant film laminated or otherwise bonded to the inner or outer surface thereof. In some embodiments, the container has an oxygen transmission rate of no more than about 10 cc/m²/24 hr at 25° C., 0% RH, 1 atm (in accordance with ASTM D 3985).

Container 10 can be constructed using any conventional process known in the art, including (but not limited to) rotational molding, blow molding, reheat stretch blow molding, injection molding, casting, roll forming, stamping, and the like.

It should be appreciated that container 10 is not limited to the shape illustrated in the Figures and can be formed as any suitable receptacle with interior 50 for housing a pouch, such as (but not limited to) a carton, can, jar, or bottle, and can take any of a wide variety of shapes as a matter of design choice. To this end, one of ordinary skill in the art would appreciate that the presently disclosed subject matter is applicable to a wide variety of shaped containers, such as rectangular, triangular, hexagonal, octagonal or square containers that can have different dimensions and volume capacities. It is also contemplated that other modifications can be made depending on the specific application and environmental requirements.

II.C. Pouch 25

As set forth above, system 5 comprises pouch 25 positioned within interior 50 of container 10. Particularly, pouch 25 can be any of the wide variety of pouches known and used in the art, including (but not limited to) stand-up pouches, gusseted stand-up pouches, lay flat pouches, pouches comprising at least one longitudinal seal, and the like. Thus, in some embodiments, pouch 25 can comprise a pair of films joined together along a pair of opposing sides and a bottom bridging the sides. Alternatively, in some embodiments, pouch 25 can be formed from a single film that has been center folded at one edge. Other methods of constructing a pouch (such as embodiments wherein the pouch includes one or more lap seals, fin seals, and/or edge seals) are well known in the art and are included within the scope of the presently disclosed subject matter.

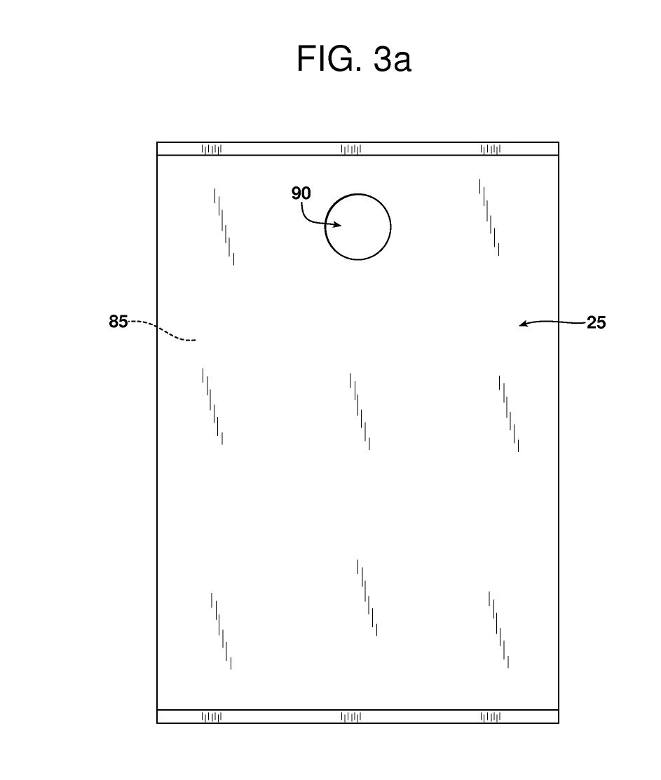

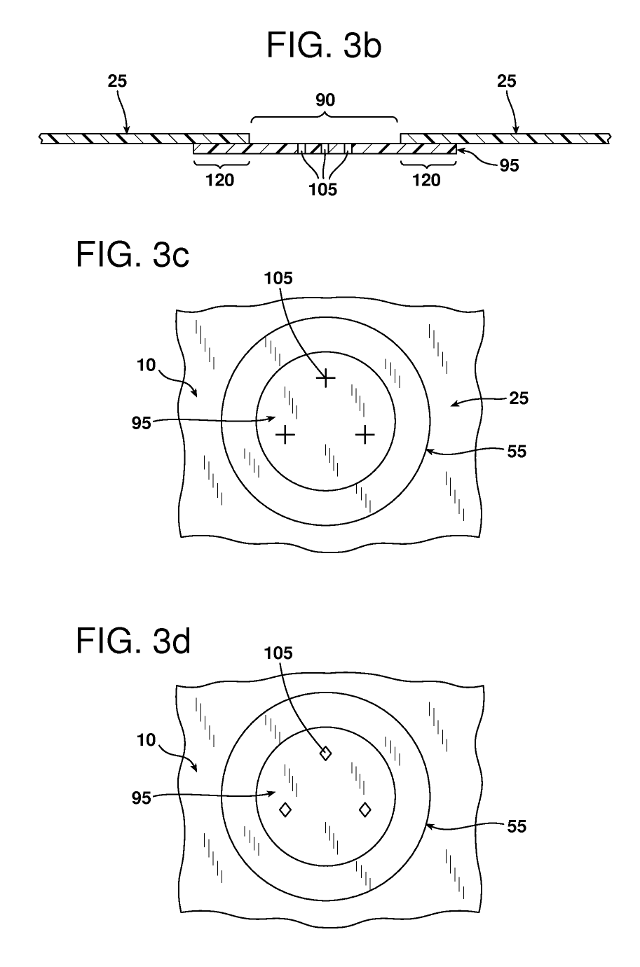

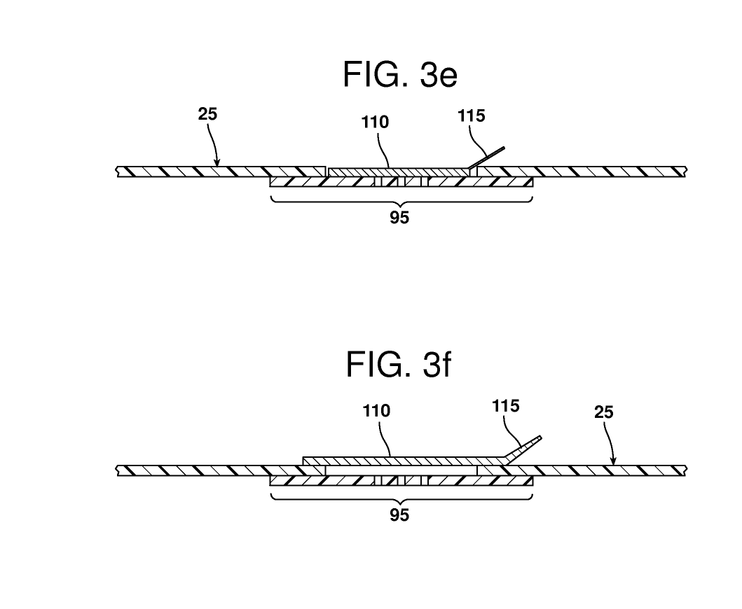

As illustrated in FIG. 3a, pouch 25 comprises reservoir 85, housing the quantity of product 35 to be dispensed. In addition, pouch 25 comprises aperture 90 that cooperates with pouch fitment 95 to define a pathway through which product can exit the disclosed system. Pouch fitment 95 is secured within the pouch interior to span pouch aperture 90, as shown in FIG. 3b. That is, at least outer edges 120 of fitment 95 can be secured via permanent adhesive, heat seal, or similar method to the interior of pouch 25 (i.e., within product reservoir 85) to cover pouch aperture 90.

Fitment 95 further includes at least one flow aperture 105 that enables product 35 to exit package 5 on demand. Flow aperture 105 extends through the valve body to allow the pouch contents to be dispensed. In some embodiments, flow aperture 105 is frangible, such that upon commencement of a dispensing operation the frangible portion ruptures and allows the aperture to be placed in an open position. In some embodiments, flow aperture 105 functions as a one-way valve, permitting backflow of product into the pouch. Flow aperture(s) 105 are not limited, and can be constructed in any suitable shape and in any suitable size. For example, FIGS. 3c and 3d illustrate one embodiment of flow apertures 105 in closed and open configurations, respectively. Product is dispensed through fitment 95 by pumping the substance at a sufficient pressure (such as through pulling the trigger of a dispensing gun) through flow aperture 105, as set forth in more detail herein below.

As shown in FIG. 3e, in some embodiments, pouch fitment 95 further comprises releasable cover 110 positioned on the external face of pouch aperture 90 to overlie flow apertures 105. Alternatively, in some embodiments, cover 110 is releasably connected about the lip of container opening 55, thereby still covering pouch aperture 90, as shown in FIG. 3f. In some embodiments, cover 110 includes radially projecting tab 115 that can be gripped by a user to peel away cover 110 prior to dispensing. Although depicted as circular in shape, it should be understood that cover 110 (and pouch aperture 90 and container opening 55) can take any of the wide variety of forms and shapes known in the art.

The disclosed pouch can be constructed from any of a wide variety of polymeric materials known in the art. In some embodiments the polymeric films used to construct the disclosed pouch can be food safe and/or have a food safe material coated thereon.

Generally, the films used to construct the disclosed pouch can be multilayer or monolayer. Typically, however, the films employed will have two or more layers to incorporate a variety of properties, such as, for example, sealability, gas impermeability, and toughness into a single film. Thus, in some embodiments, the films can comprise a total of from about 1 to about 20 layers; in some embodiments, from about 4 to about 12 layers; and in some embodiments, from about 5 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the films can comprise more than 20 layers, such as in embodiments wherein the films comprise microlayering technology.

Thus, in some embodiments, the films used to construct pouch 25 can include one or more barrier layers, bulk layers, tie layers, abuse layers, and/or sealant layers. For example, in some embodiments, the disclosed pouch and/or label includes at least one barrier layer such that the pouch has an oxygen transmission rate of no more than about 10 cc/m²/24 hr at 25° C., 0% RH, 1 atm (in accordance with ASTM D 3985).

The polymer components used to fabricate the films can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films. See, for example, U.S. Pat. Nos. 7,205,040; 7,160,378; 7,160,604; 6,472,081; 6,222,261; 6,221,470; 5,591,520; and 5,061,534, the disclosures of which are hereby incorporated by reference in their entireties. In some embodiments, pouch 25 can be constructed from a food grade material, as would be well known to those of ordinary skill in the art.

The films used to construct pouch 25 can have any total thickness so long as they provide the desired properties for the particular packaging operation in which they are to be used. Nevertheless, in some embodiments the disclosed films have a total thickness of from about 0.1 mils to about 20 mils; in some embodiments, from about 0.2 mils to about 10 mils; in some embodiments, from about 0.3 mils to about 5.0 mils; and in some embodiments, from about 1.0 mils to 3.0 mils.

The films can be provided in sheet or film form and can be any of the films commonly used for the disclosed type of packaging. To this end, the disclosed films can be constructed by any suitable process known to those of ordinary skill in the art, including (but not limited to) coextrusion, lamination, extrusion coating, and combinations thereof. See, for example, U.S. Pat. No. 6,769,227, the content of which is herein incorporated by reference in its entirety.

In some embodiments, the films can be transparent (at least in any non-printed regions) such that the packaged product is at least partially visible through the films. The term “transparent” as used herein can refer to the ability of a material to transmit incident light with negligible scattering and little absorption, enabling objects to be seen clearly through the material under typical unaided viewing conditions (i.e., the expected use conditions of the material).

The transparency of the films can be at least about any of the following values: 20%, 25%, 30%, 40%, 50%, 65%, 70%, 75%, 80%, 85%, and 95%, as measured in accordance with ASTM D1746.

Alternatively or in addition, in some embodiments the films used to construct pouch 25 can be pigmented, tinted, or printed, as would be well known to those of ordinary skill in the art. Printing can be employed at any time prior to use of the pouch. In some embodiments, pouch 25 can be ink jet or thermal transfer printed using a device mounted on a packaging machine that forms and seals the pouch.

Pouch fitment 95 can be constructed from any suitable rigid or semi-rigid material, including (but not limited to) polymeric materials. Similarly, pouch fitment 95 can be constructed using any suitable method known in the art, e.g., injection molding and the like.

III.D. Disc 40

System 5 further comprises disc 40 designed to cooperate with the piston or follower of a dispensing gun. The disc is sized and shaped to be closely received within container interior 50 at second end 20 to help ensure that the pouch is fully retained within the holder tube during dispensing. In some embodiments, disc 40 can be configured to define a mating relationship with the interior of container 10 when in contact. The disc is slidable within the interior of the container to ultimately allow product 35 to be dispensed from the pouch. Specifically, when pressure is exerted on disc 40 from a dispensing gun, the disc reacts by moving from container second end 20 towards container first end 15. As a result, pouch 25 is compressed, thereby increasing pressure on fitment aperture(s) 105 which then open to dispense product 35.

Suitable materials for use in constructing disc 40 can include (but are not limited to) plastic, wood, metal, rubber, and the like. In some embodiments, disc 40 is configured as part of a dispensing gun. Alternatively, in some embodiments, the disc can be configured as part of system 5.

III.E. Product 35

System 5 can be used to house any of a wide variety of food and non-food products. For example, product 35 can include any of a wide variety of condiments, including (but not limited to) mustard, ketchup, salsa, guacamole, cheese sauce, sour cream, taco sauce, mayonnaise, tartar sauce, syrup, gravy, hot fudge, caramel, butterscotch toppings, flowable margarine and butter, horseradish, creamers, cream, yogurt, jelly, peanut butter, and the like. Liquids (such as water, milk, lemonade, and the like) can also be packaged in accordance with the presently disclosed subject matter.

### IV. Assembly of System 5

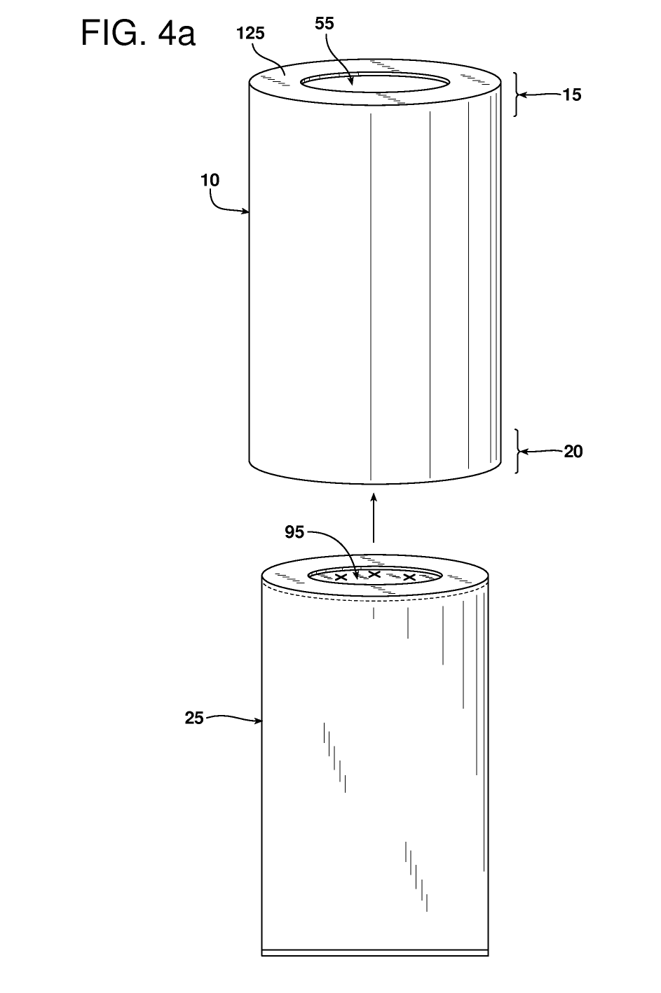

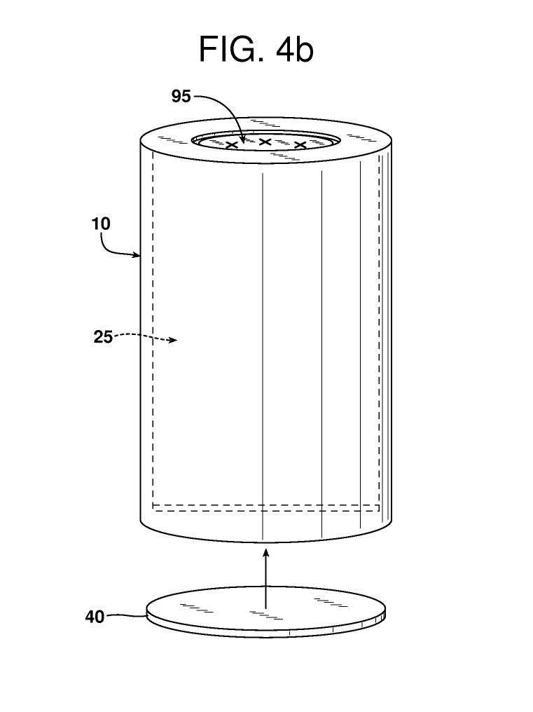

As a first step, pouch 25 can be fully or partially filled with product 35. The pouch can then be inserted into interior 50 of container 10 through second end 20 such that pouch fitment 95 abuts top face 125 of the outer container, as illustrated in FIG. 4a. In this configuration, pouch fitment 95 (and thus pouch aperture 90) is aligned with container opening 55. Disc 40 can then be inserted within the interior of container 10 at second end 20, as shown in FIG. 4b to arrive at the system of FIGS. 1a and 1b.

It should be appreciated that the steps used to assemble system 5 disclosed above are not limited and can performed in any order. In addition, in some embodiments, the package can be partially or fully pre-assembled such that a user need not perform all of the steps described herein.

### V. Methods of Using System 5

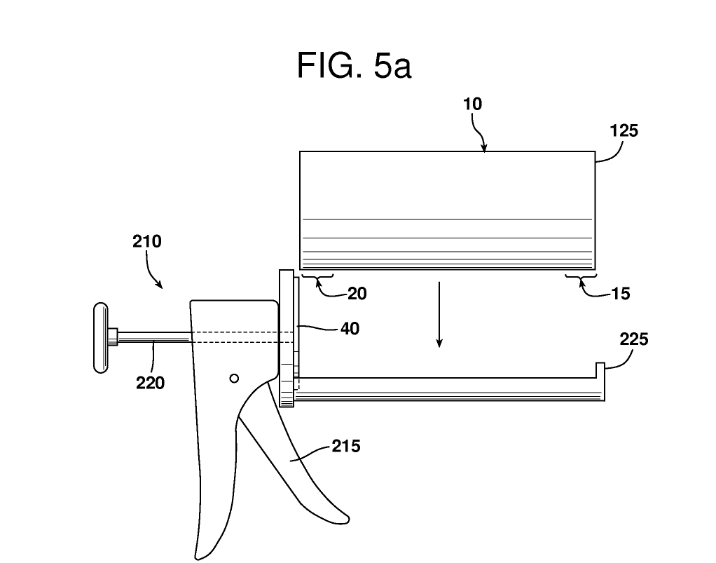

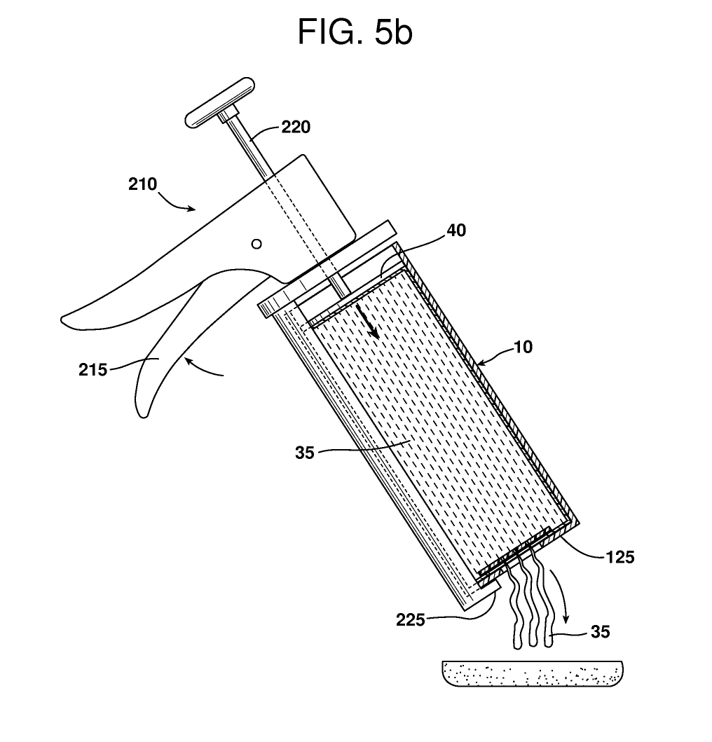

After assembly, system 5 can be inserted into a dispensing gun, as shown in FIGS. 5a and 5b. In some embodiments, dispensing gun 210 can be of the type that dispenses an accurately measured increment of the contents of pouch 25 upon each actuation. To this end, dispensing gun 210 can include trigger 215 that forms part of an actuating structure. Specifically, trigger 215 can be coupled to piston 220 that is movable within the interior of container 10 via contact with disc 55. The actuating structure functions such that upon each movement of trigger 215, the piston moves towards first end 15 of the container and a bias spring returns the trigger to the original position. In some embodiments, the dispensing gun includes wall 225 that rests against the front end of system 5 so that pressure applied by the trigger mechanism of the gun is effective to dispense the package contents. It should be understood that the disclosed package can be used with any of a wide variety of dispensing guns known in the art. See, for example, U.S. Pat. Nos. 3,687,370; 3,945,569; 4,681,524; 5,462,204; 5,812,355; 5,875,922; 6,286,718; 6,454,138; 6,533,187; 6,691,899; and 7,011,238, the entire contents of which are hereby incorporated by reference.

To dispense the product housed within the pouch, a user can remove cover 110 from the package to expose the at least one fitment aperture. The user can then initiate trigger 215 on the dispensing gun whereby piston 220 advances disc 40 within the interior of the container toward first end 15. Such movement reduces the volume of pouch 25, thereby collapsing the pouch and increasing the pouch internal pressure. As a result, product 35 is forced through flow apertures 105 of the pouch fitment. In this way, product can be dispensed in a desired pattem associated with the apertures in the dispensing cap. For example, a valve with three exit outlets will allow dispensing of three areas of product. Once the trigger has been pulled, a metered dose of product is dispensed through the one-way valve.

Piston 220 will continue to move towards the first end of container 10 with continued application of pressure (i.e., each pull of the gun trigger), thereby dispensing the contents of the pouch. When the disc has reached an abutting position with the first end of the container, the mating relationship ensures that a maximum amount of product housed within pouch 25 has been dispensed. System 5 can then be removed from dispensing gun 210 and replaced with a new system. As set forth above, in some embodiments, container 10 and/or disc 40 can be used repeatedly such that only pouch 25 is replaced.

### VI. Advantages of the Presently Disclosed Subject Matter

The disclosed packaging system as described herein above has been designed to minimize costs associated with materials and assembly and with sufficient ruggedness to survive filling, closing, packing and shipping.

System 5 and/or pouch 25 can also be economically disposed of after a single use, or after the pouch contents have been dispensed.

The disclosed pouch is flexible, thereby reducing storage space needed to house the pouch prior to use. Similarly, the space needed to ship the disclosed pouch has also been reduced. Further, the flexible pouch design requires less space (in trash and in landfills) at the time of disposal.

In addition, pouch 25 is constructed to be substantially free of voids and to have suitable mechanical integrity and flexibility. As a result, the pouch can withstand high pressure treatment, such as can be used to reduce unwanted microorganisms in the packaged product.

The disclosed package further allows the dispensing of multiple doses of product in each dispensing application. For example, a package that includes a primer with five exit apertures will allow five spots of product to be dispensed with each pull of the dispensing gun trigger.

Other objects and advantages of the invention will be apparent and are included within the subject matter of the presently disclosed subject matter.

What is claimed is:

1. A packaging system comprising:
a. a hollow outer container comprising
i. a first end comprising a container opening;
ii. an open second end; and
iii. an interior;
b. a pouch positioned within the container interior, the pouch comprising:
i. a first end comprising a pouch opening positioned to align with the container opening;
ii. a second end;
iii. an interior;
iv. a fitment comprising at least one aperture, wherein the fitment is positioned within the pouch interior to overlie the pouch opening.

2. The system of claim 1, further comprising a disc positioned within the container interior adapted to movably close the container second end.

3. The system of claim 1, wherein said pouch interior further comprises a product.

4. The system of claim 3, wherein the packaged product is a food product.

5. The system of claim 1, wherein the at least one fitment aperture is concealed by a removable cover.

6. The system of claim 1, wherein the pouch has an oxygen transmission rate of no more than 10 cc/m²/24 hr at 25° C., 0% RH, 1 atm in accordance with ASTM D 3985.

7. The system of claim 1, wherein the fitment apertures comprise a frangible portion.

8. The system of claim 1, wherein the fitment apertures are one-way valves.

9. A method of dispensing a product, comprising:
a. providing the system of claim 2;
b. at least partially filling the pouch with a product to be dispensed;
c. providing a dispensing gun configured to house the disclosed system;
d. inserting the system into the dispensing gun;
e. initiating movement of the disc towards the first end of the container, wherein movement of the disc dispenses the product through the at least one fitment aperture.

10. The method of claim 9, wherein the initiation of the disc is accomplished by activating a dispensing gun trigger.

11. The method of claim 9, wherein a metered volume of product is dispensed.

12. The method of claim 9, wherein the product is a food product.

13. The method of claim 9, wherein the pouch has an oxygen transmission rate of no more than 10 cc/m²/24 hr at 25° C., 0% RH, 1 atm in accordance with ASTM D 3985.

14. The method of claim 9, wherein the at least one fitment aperture of the system is concealed by a removable cover.

15. The method of claim 14, comprising the additional step of removing the cover prior to initiating movement of the disc.
